(19) United States
(12) Patent Application Publication
(10) Pub. No.: US 2025/0206115 A1
(43) Pub. Date: Jun. 26, 2025

(54) Seal Assembly Including An Electromagnetic Adhesive

(71) Applicant: Henniges Automotive Sealing Systems North America, Inc., Wilmington, DE (US)

(72) Inventors: Thomas David Groters, Waterford, MI (US); Arthur Allen Krajenke, Auburn Hills, MI (US); Henry G. Zilka, Oxford, MI (US)

(73) Assignee: Henniges Automotive Sealing Systems North America, Inc., Wilmington, DE (US)

(21) Appl. No.: 18/848,440

(22) PCT Filed: May 19, 2023
(86) PCT No.: PCT/US2023/022915

§ 371 Date: Sep. 18, 2024

Related U.S. Application Data
(60) Provisional application No. 63/343,796, filed on May 19, 2022.

(51) Int. Cl. B60J 10/38; B29C 48/12; B29C 48/21; B29K 105/00; B29L 31/30; B60J 10/15; B60J 10/265; B60J 10/84; B60J 10/86

(52) U.S. Cl. CPC B60J 10/38; B60J 10/15; B60J 10/265; B60J 10/84; B29C 48/12; B29C 48/21; B29K 2105/0097; B29L 2031/302; B60J 10/86

(57) ABSTRACT

A seal assembly is adapted to be coupled to a flange of a vehicle. The seal assembly includes a seal body extruded from an elastomeric material and having a base, a first leg, and a second leg collectively defining a mounting channel for receiving the flange of the vehicle. The seal assembly also includes at least one seal feature co-extruded with the seal body, extending from the body, and spaced from the mounting channel. The seal assembly further includes a molded component coupled to the seal body and molded from a thermoplastic material. The seal assembly further includes an electromagnetic adhesive disposed between the seal body and the molded component. The electromagnetic adhesive includes a resin and a susceptor configured to be energized upon exposure to electromagnetic energy such that the susceptor softens the resin to directly mount the molded component to the seal body.

### CROSS-REFERENCE TO RELATED APPLICATIONS

The subject patent application claims priority to and all the benefits of U.S. Provisional Patent Application No. 63/343,796, which was filed on May 19, 2022, which is herein incorporated by reference in its entirety.

### BACKGROUND OF THE INVENTION

### 1. Field of the Invention

The invention relates generally to seal assemblies adapted to be coupled to a flange of a vehicle.

### 2. Description of the Related Art

Motor vehicles are typically equipped with vehicle doors and vehicle windows. The vehicle windows may be moveable (such as a vertical moving window of the vehicle door) or may be stationary (such as a quarter window on the vehicle door). The vehicle doors and vehicle windows are required to be sealed with a seal assembly. Seal assemblies commonly include a seal body comprised of an elastomeric material and a molded component comprised of a plastic material. Combining seal bodies comprised of elastomeric material and molded components comprised of plastic material in a single seal assembly is challenging due to the difficulty of bonding elastomeric material and plastic material without the aid of mechanical fastening which can add cost and manufacturing time to the seal assembly. Moreover, mechanical fastening often fails to provide a water-tight seal between the seal body and the molded component.

As such, there remains a need to provide an improved seal assembly.

### SUMMARY OF THE INVENTION AND ADVANTAGES

A seal assembly is adapted to be coupled to a flange of a vehicle. The seal assembly includes a seal body extruded from an elastomeric material. The seal body has a base, a first leg extending from the base, and a second leg extending from the base spaced from the first leg. The base, the first leg, and the second leg collectively define a mounting channel for receiving the flange of the vehicle. The seal assembly also includes at least one seal feature co-extruded with the seal body. The seal feature extends from the seal body and is spaced from the mounting channel. The seal assembly further includes a molded component coupled to the seal body and molded from a thermoplastic material. The seal assembly further still includes an electromagnetic adhesive disposed between the seal body and the molded component. The electromagnetic adhesive is comprised of a resin and a susceptor configured to be energized upon exposure to electromagnetic energy such that the susceptor softens the resin to directly mount the molded component to the seal body.

A seal assembly adapted to be coupled to a flange of a vehicle, the seal assembly comprising a seal body extruded from an elastomeric material and having a base defining a mounting surface. At least one seal feature co-extruded with the seal body with the seal feature extending from the seal body and spaced from the mounting surface. A molded component coupled to the seal body and molded from a thermoplastic material with the molded component having an attachment feature for engaging the flange of the vehicle. An electromagnetic adhesive disposed between the mounting surface of the seal body and the molded component, with the electromagnetic adhesive comprised of a resin and a susceptor configured to be energized upon exposure to electromagnetic energy such that the susceptor softens the resin to directly mount the molded component to the seal body.

As such, the seal body extruded from the elastomeric material and the molded component molded from the thermoplastic material are directly mounted to one another through the electromagnetic adhesive. Direct mounting of the seal body and the molded component can thus be accomplished inexpensively and with reduced manufacturing time.

### BRIEF DESCRIPTION OF THE DRAWINGS

Other advantages of the present invention will be readily appreciated, as the same becomes better understood by reference to the following detailed description when considered in connection with the accompanying drawings.

FIG. 1A is a cross-sectional view of a seal assembly with a molded component spaced therefrom.

FIG. 1B is a cross-sectional view of the seal assembly of FIG. 1A with the molded component mounted to the seal body.

FIG. 2 is a cross-sectional view of an alternative seal assembly with an alternative molded component mounted thereto.

FIG. 3 is a cross-sectional view of another alternative seal assembly an alternative molded component mounted to the seal assembly.

FIG. 4 is a schematic illustration of the seal assembly including the seal body and the electromagnetic adhesive.

FIG. 5 is a schematic illustration of the seal assembly, the electromagnetic adhesive, and the molded component, with a radiofrequency (RF) coil.

### DETAILED DESCRIPTION OF THE INVENTION

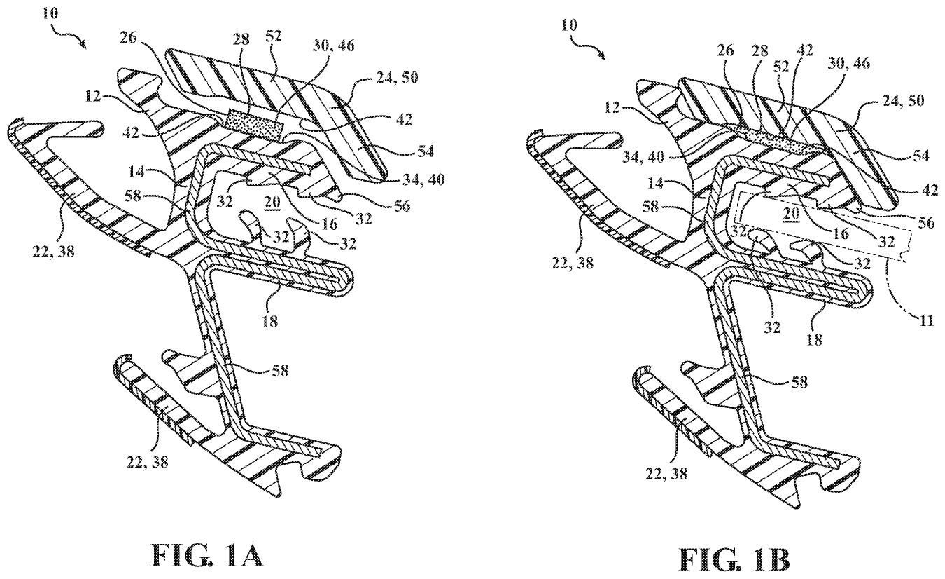

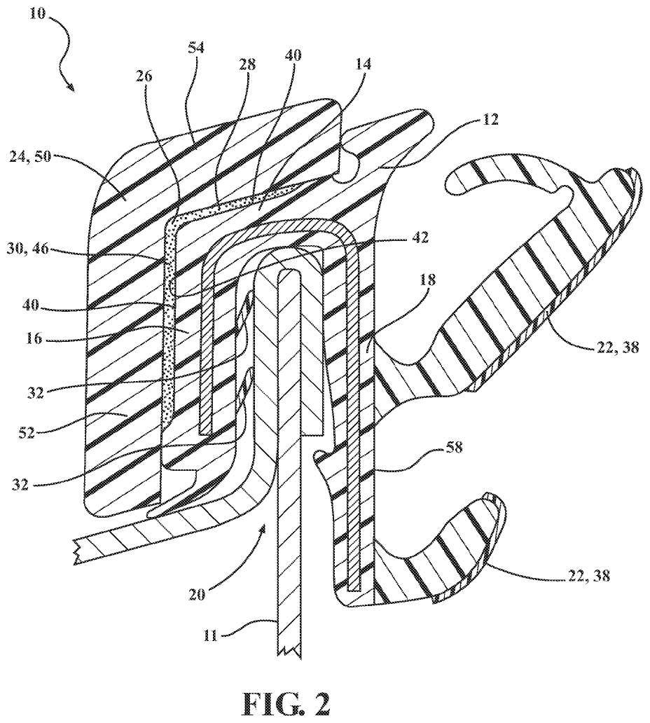

With reference to the Figures, wherein like numerals indicate like parts throughout the several views, a seal assembly 10 is adapted to be coupled to a flange 11 of a vehicle. In one embodiment, as shown in FIGS. 1A, 1B, and 2, the seal assembly 10 includes a seal body 12 extruded from an elastomeric material. The seal body 12 has a base 14, a first leg 16 extending from the base 14, and a second leg 18 extending from the base 14 spaced from the first leg 16. The base 14, the first leg 16, and the second leg 18 collectively define a mounting channel 20 for receiving the flange 11 of the vehicle. The seal assembly 10 also includes at least one seal feature 22 co-extruded with the seal body 12. The seal feature 22 extends from the seal body 12 and is spaced from the mounting channel 20.

The seal assembly 10 further includes a molded component 24 coupled to the seal body 12 and molded from a thermoplastic material. The seal assembly 10 further still includes an electromagnetic adhesive 26 disposed between the seal body 12 and the molded component 24. The electromagnetic adhesive 26 is comprised of a resin 28 and a susceptor 30 configured to be energized upon exposure to electromagnetic energy such that the susceptor 30 softens the resin 28 to directly mount the molded component 24 to the seal body 12.

As such, the seal body 12 extruded from the elastomeric material and the molded component 24 molded from the thermoplastic material are directly mounted to one another through the electromagnetic adhesive 26. In a preferred embodiment, without a need for mechanical fastening as discussed below. Direct mounting of the seal body 12 and the molded component 24 can thus be accomplished inexpensively and with reduced manufacturing time. Moreover, the electromagnetic adhesive 26 results in a strong bond between the seal body 12 and the molded component 24, and thus the direct mounting of the seal body 12 to the molded component 24 is secure.

With reference to FIGS. 1A, 1B, and 2, as mentioned above, the base 14, the first leg 16, and the second leg 18 collectively define the mounting channel 20. The mounting channel 20 may be configured to receive the flange 11 of the vehicle. More specifically, the seal body 12 may further include a plurality of gripping fins 32 extending from at least one of the first leg 16 and the second leg 18 for engaging the flange 11 of the vehicle. In other words, the plurality of gripping fins 32 may extend from the first leg 16, may extend from the second leg 18, or may extend from both the first leg 16 and the second leg 18. The plurality of gripping fins 32 may extend into the mounting channel 20. The plurality of gripping fins 32 may be configured to abut the flange 11 of the vehicle to mount the seal assembly 10 to the vehicle.

It is to be appreciated that the flange 11 may be a component of the vehicle door or other vehicle panel. More specifically, the vehicle door may include a frame, such as a window frame, and the flange 11 may either be a component of the frame or may be a separate component from the frame which generally follows the contour of the vehicle door. Alternatively still, the vehicle may include a vehicle panel separate from the vehicle door, and the vehicle panel may include the flange 11. The vehicle panel may be a side panel, a front panel, or a roof panel, among other possibilities.

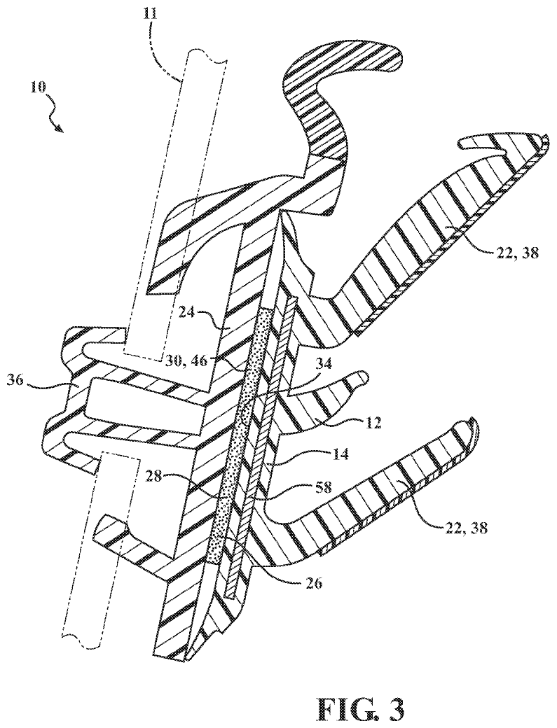

In another embodiment, as shown in FIG. 3, the seal assembly 10 includes a seal body 12 extruded from an elastomeric material. The seal body 12 has a base 14 defining a mounting surface 34. The seal assembly 10 also includes at least one seal feature 22 co-extruded with the seal body 12. The at least one seal feature 22 extends from the seal body 12 and is spaced from the mounting surface 34. The seal assembly 10 also includes a molded component 24 coupled to the seal body 12. The molded component 24 is molded from a thermoplastic material, and the molded component 24 has an attachment feature 36 for engaging the flange 11 of the vehicle. The seal assembly 10 further still includes an electromagnetic adhesive 26 disposed between the mounting surface 34 of the seal body 12 and the molded component 24. The electromagnetic adhesive 26 is comprised of a resin 28 and a susceptor 30 configured to be energized upon exposure to electromagnetic energy such that the susceptor 30 softens the resin 28 to directly mount the molded component 24 to the seal body 12.

It is to be appreciated that the embodiment shown in FIG. 3 also permits the seal body 12 extruded from the elastomeric material and the molded component 24 molded from the thermoplastic material to be directly mounted to one another through the electromagnetic adhesive 26. As mentioned above and in more detail below, preferably no mechanical fastening is required. Direct mounting of the seal body 12 and the molded component 24 can thus be accomplished inexpensively and with reduced manufacturing time. Moreover, the electromagnetic adhesive 26 results in a strong bond between the seal body 12 and the molded component 24, and thus the direct mounting of the seal body 12 to the molded component 24 is secure.

Moreover, still with reference to FIG. 3 and as mentioned above, the molded component 24 may have the attachment feature 36 for engaging the flange 11 of the vehicle. The attachment feature 36 enables attachment of the seal assembly 10 to the vehicle. More specifically, the flange 11 may include a hole, indentation, or other void, and the attachment feature 36 may be disposable in the hole, indentation, or other void. The flange 11 of the vehicle may be a component of the vehicle door. More specifically, the vehicle door may include a frame, such as a window frame, and the flange 11 may either be a component of the frame or may be a separate component from the frame which generally follows the contour of the vehicle door. Alternatively, the vehicle may include a vehicle panel separate from the vehicle door, and the vehicle panel may include the flange 11. The vehicle panel may be a side panel, a front panel, or a roof pane, among other possibilities.

As shown in FIGS. 1A, 1B, and 2, the at least one seal feature 22 co-extruded with the seal body 12 may be flocked to provide a flow friction coating exhibiting reduced sliding friction between the seal feature 22 and an object in contact, or contactable, with the seal feature 22. The object contactable with the seal feature 22 may be the vehicle window. Particularly, the object contactable with the seal feature 22 may be the moveable vehicle window. The seal feature 22 being flocked reduces the tendency of the seal body 12 and the moveable vehicle window to squeak as the vehicle window moves between open and closed positions. Flocked surfaces are particularly sensitive to both pressure and heat during the manufacture of the seal assembly 10, and thus pose a challenge to manufacture. However, flocked surfaces may be extruded.

Additionally, the seal feature 22 may be further defined as a sealing lip 38 extending outwardly from the seal body 12. The sealing lip 38 may be flocked as described herein. Alternatively, the seal feature 22 may be a sealing bulb. The sealing bulb may also be flocked as described herein.

As shown in FIGS. 1A, 1B, and 2, at least one of the base 14 and the first leg 16 has an outer surface 40 spaced from the mounting channel 20 and the seal feature 22. In other words, the base 14 may have the outer surface 40, the first leg 16 may have the outer surface 40, or both the base 14 and the first leg 16 may together have the outer surface 40. The electromagnetic adhesive 26 may be disposed on the outer surface 40. Although not required, the molded component 24 may abut at least one of the base 14 and the first leg 16 in addition to being directly mounted to the seal body 12 by the electromagnetic adhesive 26. Said differently, the molded component 24 may abut the base 14, may abut the first leg 16, or may abut both the base 14 and the first leg 16. Alternatively, the electromagnetic adhesive 26 may provide the entire contact surface for the molded component 24 to the seal body 12 such that there is no abutment between the molded component 24 and the seal body 12.

The outer surface 40 may define a notch 42, and the electromagnetic adhesive 26 may be disposed in the notch 42, as shown in FIG. 1A. The notch 42 may be a single notch having a single volume or a series of spaced notches of the same or varying volumes. Further, the single or plurality of notches may be on any portion of the outer surface(s) 40. The volume of the notch is preferably designed to be fully occupied (or filled) by the electromagnetic adhesive to as to prevent any air gaps that may degrade the bonding characteristics or watertightness of the design. The electromagnetic adhesive 26 may be disposed in the notch 42 either before softening, after softening, or both before and after softening. It is to be appreciated that the electromagnetic adhesive 26 may become disposed in the notch 42 upon softening. Moreover, the electromagnetic adhesive 26 may partially or fully fill the notch 42 upon softening. The electromagnetic adhesive 26 may be shaped to conform to the notch 42 when the molded component 24 is mounted to the seal body 12 (e.g., after softening). The electromagnetic adhesive 26 may be shaped to conform to the notch 42 as a result of the susceptor 30 softening the resin 28, as shown in FIG. 1B. However, it is to be appreciated that the electromagnetic adhesive 26 may be pre-shaped to conform to the notch 42 before the susceptor 30 softens the resin 28.

As shown in FIGS. 1A, 1B, and 2, the molded component 24 may be directly mounted to the seal body 12 through the electromagnetic adhesive 26 without mechanical fastening between the molded component 24 and the seal body 12. However, the molded component 24 may be directly mounted to the seal body 12 through the electromagnetic adhesive 26, and the molded component 24 may also be directly mounted to the seal body 12 through mechanical fastening. The mechanical fastening may serve as a redundant measure to increase the strength of the mounting. Mechanical fastening may even serve as the primary mounting mechanism, and the electromagnetic adhesive 26 may increase the strength of the mounting, form a water-tight seal between the seal body 12 and the molded component 24, or both increase the strength of the mounting and form a water-tight seal.

The electromagnetic energy may be further defined as an alternating magnetic field. The electromagnetic energy, whether taking the form of an alternating magnetic field or otherwise, may be applied to the electromagnetic adhesive 26 through use of a radiofrequency (RF) coil 44, as shown in FIG. 5. Although shown below seal body 12 and arranged to emit electromagnetic energy through the seal body 12 to the electromagnetic adhesive 26, it is to be appreciated that the radiofrequency (RF) coil 44 may be arranged in any spatial relationship relative to the seal body 12, the electromagnetic adhesive 26, and the molded component 24. In another non-limiting example, the radiofrequency (RF) coil 44 may be arranged to emit the electromagnetic energy through the molded component 24 to the electromagnetic adhesive 26.

The radiofrequency (RF) coil 44 may be cooled, for example, by a coolant such as water. The radiofrequency (RF) coil emits the electromagnetic energy (e.g., creates an alternating magnetic field), which energizes the susceptor 30 in the resin 28. The susceptor 30 in the resin 28 may then increase in temperature, and heat is transferred to from the susceptor 30 to the resin 28. The resin 28 then softens in response to the heat transferred from the susceptor 30. The softened resin 28 bonds the seal body 12 to the molded component 24. The process of energizing the susceptor 30 and softening the resin 28 to mount the seal body 12 to the molded component 24 may be referred to as electromagnetic welding.

It is to be appreciated that the resin 28 need only soften and need not melt, although it is contemplated that the resin 28 may melt. The resin 28 may approach, but not reach, a melting point of the resin 28. However, it is further to be appreciated that the resin 28 may not even be capable of melting. In other words, the resin 28 may be comprised of a material without a melting point. Instead, as a non-limiting example, the resin 28 may be comprised of a material with a glass transition temperature. In these embodiments, the resin 28 may approach, or reach, the glass transition temperature of the resin 28.

The susceptor 30 may be further defined as a plurality of susceptor particles 46 impregnated in the resin 28. The susceptor 30 may also be a singular component, such as a strip, or may be divided into multiple components. The susceptor 30 may comprise a ferromagnetic material, whether in the form of the singular component, multiple components, or as the plurality of particles 46. The ferromagnetic material may include at least one chosen from iron, nickel, and magnetite. In other words, the susceptor 30 may include iron, nickel, magnetite, or any combination of iron, nickel, and magnetite.

The seal body 12 extends along an axis A1. In a non-limiting example, the electromagnetic adhesive 26 may be applied to the seal body 12 continuously along the axis A1. Moreover, although not required, the electromagnetic adhesive 26 may be co-extruded with the seal body 12. Co-extrusion of the seal body 12 and the electromagnetic adhesive 26 further reduces the complexity, cost, and manufacturing time of the seal assembly 10. The electromagnetic adhesive 26 may be co-extruded with the seal body 12 as a simple ribbon or as a plurality of discrete beads. It is to be appreciated that co-extrusion of the electromagnetic adhesive 26 with the seal body 12 may also apply the electromagnetic adhesive 26 to the seal body 12 continuously along the axis A1.

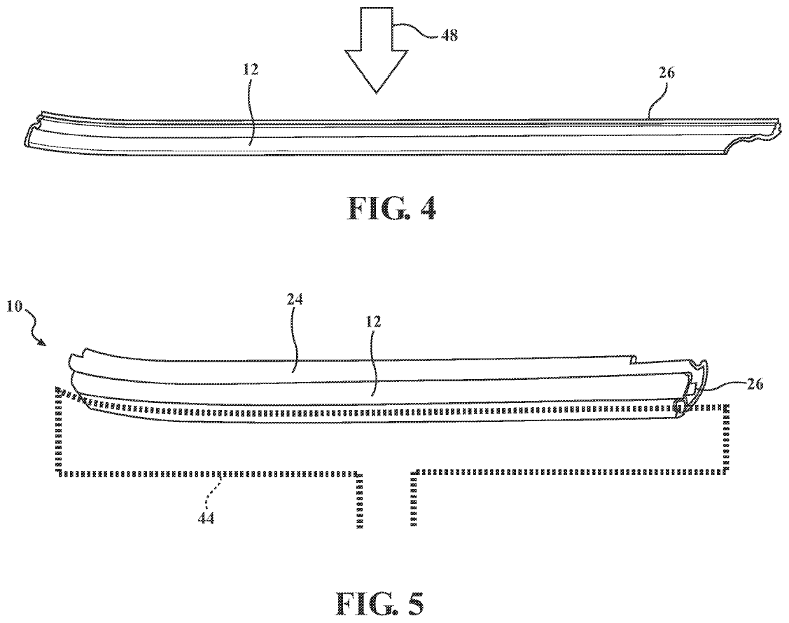

In the embodiments where the seal body 12 and the electromagnetic adhesive 26 are co-extruded, as shown in FIG. 4, a tool 48 may apply pressure against one or both of the seal body 12 and the electromagnetic adhesive 26 during co-extrusion, optionally within the tool 48. As described herein, co-extrusion of the seal body 12 and the electromagnetic adhesive 26 may advantageously result in the electromagnetic adhesive 26 being applied along the full length of the seal body 12, thus providing a continuous, high-strength, uninterrupted bond between the seal body 12 and the electromagnetic adhesive 26. The continuous, high-strength, uninterrupted bond between the seal body 12 and the electromagnetic adhesive 26 prevents water from passing between the seal body 12 and the electromagnetic adhesive 26, thus ensuring a water-tight seal therebetween.

However, it is also to be appreciated that the electromagnetic adhesive 26 may be formed separately, such as through extrusion, and later applied to the seal body 12 such that the electromagnetic adhesive 26 is applied to the seal body 12 continuously along the axis A1. As a non-limiting example, the electromagnetic adhesive 26 may be robotically applied to one or both of the seal body 12 and the molded component 24 after the seal body 12 has been extruded. It is to be appreciated that a water-tight seal may still be formed between the seal body 12 and the electromagnetic adhesive 26 even if the electromagnetic adhesive 26 is formed separately and later applied to the seal body 12.

Moreover, in the embodiments where the electromagnetic adhesive 26 is formed separately and later applied, the electromagnetic adhesive 26 may first be applied to the molded component 24. In other words, the electromagnetic adhesive 26 may be applied to the molded component 24, and the combined electromagnetic adhesive 26 and molded component 24 may then be applied to the seal body 12. The notch 42 may still be present on the seal body 12 to receive the adhesive 26 on the molded component 24. Alternatively, the molded component 24 may define a notch, and the electromagnetic adhesive 26 may be disposed in the notch on the molded component. The electromagnetic adhesive 26 may be disposed in the notch 42 either before softening, after softening, or both before and after softening. It is to be appreciated that the electromagnetic adhesive 26 may become disposed in the notch 42 upon softening. Moreover, the electromagnetic adhesive 26 may partially or fully fill the notch 42 upon softening. The electromagnetic adhesive 26 may be shaped to conform to the notch 42 when the molded component 24 is mounted to the seal body 12 (e.g., after softening). The electromagnetic adhesive 26 may be shaped to conform to the notch 42 as a result of the susceptor 30 softening the resin 28. However, it is to be appreciated that the electromagnetic adhesive 26 may be pre-shaped to conform to the notch 42 before the susceptor 30 softens the resin 28.

The molded component 24 may be molded separate from the seal body 12. In a non-limiting example, the molded component 24 may be molded through injection molding. The molded component 24 may even be over-molded onto the seal body 12 through injection over-molding. The molded component 24 may take many forms corresponding to many applications in the vehicle. As a non-limiting example, the seal assembly 10 may be further defined as an outer waist belt weatherstrip, which assists in functional sealing while also being aesthetically pleasing. In another non-limiting example, as shown in FIGS. 1A, 1B, and 2, the molded component 24 may be a decorative cover 50. The decorative cover 50 serves to hide the seal body 12 from view. Decorative covers are often subject to harsh conditions when operating the vehicle due to their exposure, repeated use, and impact with foreign objects (e.g., rocks), and thus must be mounted securely to the seal body 12 to prevent the decorative cover 50 from detaching from the seal body 12. As such, the bond formed by the electromagnetic adhesive 26 must be particularly robust when mounting the decorative cover 50 to the seal body 12.

Moreover, the decorative cover 50 may have a first cover portion 52 extending parallel to the first leg 16 of the seal body 12 and a second cover portion 54 extending at an angle from the first cover portion 52. The electromagnetic adhesive 26 may be disposed between the first cover portion 52 and the first leg 16. The angle may be between about 5 degrees and about 135 degrees, between about 10 degrees and about 90 degrees, between about 10 degrees and about 75 degrees, between about 10 degrees and about 60 degrees, between about 10 degrees and about 45 degrees, between about 10 degrees and about 40 degrees, or between about 15 degrees and about 35 degrees.

In one embodiment, as shown in FIGS. 1A and 1B, the second cover portion 54 extends toward a distal end 56 of the first leg 16 of the seal body 12. It is to be appreciated that the first cover portion 52 may be in contact with a portion the base 14 depending on how the base 14 is interpreted. Further, the second cover portion 54 need not be in contact with the distal end 56 of the first leg 16. Moreover, the second cover portion 54 may be in contact with the distal end 56 of the first leg 16, but the first cover portion 52 need not be in contact with the base 14.

In another embodiment, as shown in FIG. 2, the second cover portion 54 extends over at least a portion of the base 14 while the first cover portion 52 extends over the first leg 16. In this embodiment, the electromagnetic adhesive 26 may be disposed between the second cover portion 54 and the base 14. It is to be appreciated that the electromagnetic adhesive 26 may be disposed between the second cover portion 54 and the base 14, and may also be disposed between the first cover portion 52 and the first leg 16. The electromagnetic adhesive 26 may be applied before softening such that the electromagnetic adhesive 26 extends continuously adjacent to the first leg 16 and the base 14, or may be applied before softening such that the electromagnetic adhesive 26 extends continuously adjacent to the first cover portion 52 and the second cover portion 54. However, the electromagnetic adhesive 26 may alternatively be applied discontinuously in two or more discrete beads, with at least a first bead disposed between the first cover portion 52 and the first leg 16 and at least a second bead disposed between the second cover portion 54 and the base 14. The first bead and the second bead may remain discontinuous upon softening, or the first bead and the second bead may combine upon softening to become continuous.

The seal body 12 may further include an embedded reinforcing member 58. The embedded reinforcing member may be for reinforcing the mounting channel 20 or otherwise stiffening the seal body 12. The embedded reinforcing member 58 may be comprised of a metal, a hard plastic, or any other material capable of reinforcing the structural integrity of the seal body 12.

The resin 28 may include a thermoplastic. In a non-limiting example, the resin 28 includes polypropylene. However, the resin 28 may include any combination of polyolefins, such as but not limited to polyethylene, polybutylene, polymethylpentene, olefin block copolymers, ethylene-octene copolymers, and propylene-butane copolymers. The molded component 24 may include thermoplastic olefin (TPO), such as but not limited to polypropylene, polyethylene, polybutylene, polymethylpentene, olefin block copolymers, ethylene-octene copolymers, and propylene-butane copolymers. The molded component 24 may also include acrylonitrile butadiene styrene (ABS) and polycaprolactone (PCL), or may include a thermoset material. The elastomeric material of the seal body 12 may include at least one chosen from a thermoplastic vulcanizate (TPV) and an ethylene propylene diene monomer (EPDM) rubber. In other words, the elastomeric material of the seal body 12 may include thermoplastic vulcanizate (TPV), ethylene propylene diene monomer (EPDM) rubber, or a combination of thermoplastic vulcanizate (TPV) and ethylene propylene diene monomer (EPDM) rubber. The elastomeric material of the seal body 12 may also include thermoplastic elastomer (TPE), thermoplastic olefin (TPO), thermoplastic polyurethane (TPU), or thermoplastic styrenic elastomers (TPS).

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A seal assembly adapted to be coupled to a flange of a vehicle, said seal assembly comprising:
a seal body extruded from an elastomeric material and having a base, a first leg extending from said base, and a second leg extending from said base spaced from said first leg, with said base, said first leg, and said second leg collectively defining a mounting channel for receiving the flange of the vehicle;
at least one seal feature co-extruded with said seal body with said seal feature extending from said seal body and spaced from said mounting channel;
a molded component coupled to said seal body and molded from a thermoplastic material; and
an electromagnetic adhesive disposed between said seal body and said molded component, with said electromagnetic adhesive comprised of a resin and a susceptor configured to be energized upon exposure to electromagnetic energy such that said susceptor softens said resin to directly mount said molded component to said seal body.

2. The seal assembly of claim 1, wherein at least one of said base and said first leg has an outer surface spaced from said mounting channel and said seal feature, and wherein said electromagnetic adhesive is disposed on said outer surface.

3. The seal assembly of claim 2, wherein said molded component abuts at least one of said base and said first leg in addition to being directly mounted to said seal body by said electromagnetic adhesive.

4. The seal assembly of claim 2, wherein said outer surface defines a notch, and wherein said electromagnetic adhesive is disposed in said notch.

5. The seal assembly of claim 4, wherein said electromagnetic adhesive is shaped to conform to said notch when said molded component is mounted to said seal body.

6. The seal assembly of claim 5, wherein said electromagnetic adhesive conforms to a volume of said notch as a result of said susceptor softening said resin.

7. The seal assembly of claim 1, wherein said molded component is directly mounted to said seal body through said electromagnetic adhesive without mechanical fastening between said molded component and said seal body.

8. The seal assembly of claim 1, wherein said electromagnetic energy is further defined as an alternating magnetic field.

9. The seal assembly of claim 1, wherein said susceptor is further defined as a plurality of susceptor particles impregnated in said resin.

10. The seal assembly of claim 1, wherein said susceptor comprise a ferromagnetic material.

11. The seal assembly of claim 10, wherein said ferromagnetic material comprises at least one chosen from iron, nickel, and magnetite.

12. The seal assembly of claim 1, wherein said seal body extends along an axis, and wherein said electromagnetic adhesive is applied to said seal body continuously along said axis.

13. The seal assembly of claim 1, wherein said electromagnetic adhesive is co-extruded with said seal body.

14. The seal assembly of claim 1, wherein said molded component is molded separate from said seal body.

15. The seal assembly of claim 1, wherein said molded component is a decorative cover having a first cover portion extending parallel to said first leg of said seal body and a second cover portion extending at an angle from said first cover portion.

16. The seal assembly of claim 15, wherein said electromagnetic adhesive is disposed between said first cover portion and said first leg.

17. The seal assembly of claim 15, wherein said second cover portion extends toward a distal end of said first leg of said seal body.

18. The seal assembly of claim 15, wherein said electromagnetic adhesive is disposed between said second cover portion and said base.

19. The seal assembly of claim 1, wherein said seal body further includes an embedded reinforcing member for reinforcing said mounting channel.

20-24. (canceled)

25. A seal assembly adapted to be coupled to a flange of a vehicle, said seal assembly comprising:
a seal body extruded from an elastomeric material and having a base defining a mounting surface;
at least one seal feature co-extruded with said seal body with said seal feature extending from said seal body and spaced from said mounting surface;
a molded component coupled to said seal body and molded from a thermoplastic material with said molded component having an attachment feature for engaging the flange of the vehicle; and
an electromagnetic adhesive disposed between said mounting surface of said seal body and said molded component, with said electromagnetic adhesive comprised of a resin and a susceptor configured to be energized upon exposure to electromagnetic energy such that said susceptor softens said resin to directly mount said molded component to said seal body.

26. The seal assembly of claim 25, wherein said molded component is directly mounted to said seal body through said electromagnetic adhesive without mechanical fastening between said molded component and said seal body.

27. (canceled)

28. The seal assembly of claim 25, wherein said susceptor is further defined as a plurality of susceptor particles impregnated in said resin and wherein said plurality of susceptor particles comprise a ferromagnetic material.

29-30. (canceled)

31. The seal assembly of claim 25, wherein said seal body extends along an axis, and wherein said electromagnetic adhesive is applied to said seal body continuously along said axis.

32. The seal assembly of claim 25, wherein said electromagnetic adhesive is co-extruded with said seal body.

33. The seal assembly of claim 25, wherein said molded component is molded separate from said seal body.

34-37. (canceled)
